(19) United States
(12) Patent Application Publication
(10) Pub. No.: US 2023/0104980 A1
(43) Pub. Date: Apr. 6, 2023

(54) Metering Device for Bulk Material

(71) Applicant: Motan Holding GmbH, Konstanz (DE)

(72) Inventors: Gerold Müller, Isny (DE); Andreas Steinke, Wangen im Allgäu (DE)

(21) Appl. No.: 17/955,910

(22) Filed: Sep. 29, 2022

(30) Foreign Application Priority Data
Oct. 5, 2021 (DE) 10 2021 005 028.2

(51) Int. Cl. F16K 3/02; G01F 11/00

(52) U.S. Cl. CPC F16K 3/0209; G01F 11/003; F16K 3/0281

(57) ABSTRACT

A metering device for bulk material has a metering container with an outlet opening provided with a rim. A slide is connected to a slide drive and closes the outlet opening. The slide is provided with a slide rim. The rim of the outlet opening and the slide rim, as a function of a displacement travel of the slide in a displacement direction, determine a travel-dependent outlet cross section of the outlet opening. The rim of the outlet opening; or the slide rim; or the rim of the outlet opening and the slide rim extend at a slant to the displacement direction of the slide.

### BACKGROUND OF THE INVENTION

The invention concerns a metering device for bulk material with at least one metering container that is provided with at least one outlet opening that can be closed by a slide connected to a slide drive.

Metering devices are used in particular in the plastics industry and serve to supply the bulk materials used for the plastic products in precisely metered quantities to a processing machine. The bulk materials are stored in a metering container from where the bulk materials exit in a metered fashion through an outlet opening. The latter can be closed by a slide that by means of a slide drive can be moved from a closed position into an open position. For example, plungers are known as slides and can be moved into an outlet opening in order to close it. The diameter of the plunger and of the outlet opening limit the medium to be metered to a certain throughput range that is predetermined by geometries of the plunger and of the outlet opening. When the user desires to change his recipe after a certain amount of time and to do so must leave the predetermined metering range, he must convert the metering device, if this is even possible at all. Therefore, the metering range of the known metering devices is relatively small and not very variable.

The invention has the object to configure the metering device of the aforementioned kind such that with a simple constructive configuration the metering rate can be adapted in a simple manner to the respective bulk material to be metered and to the quantity.

### SUMMARY OF THE INVENTION

This object is solved for the metering device of the aforementioned kind in accordance with the invention in that the outlet opening and/or the slide comprises a rim extending at a slant to the displacement direction of the slide, and in that the rims of the outlet opening and of the slide, as a function of the displacement travel of the slide, determine the travel-dependent outlet cross section of the outlet opening.

In the metering device according to the invention, it is provided that the outlet opening is limited by two oppositely positioned rims of which one rim is provided at the slide. In the closed position, the slide closes the outlet opening completely. Starting from this closed position, the rim of the slide reaches the region of the outlet opening. As soon as the rim of the slide has been pushed past the neighboring rim of the outlet opening, an outlet cross section of the outlet opening that depends on the position of the slide is provided through which the bulk material can pass from the metering container to the exterior.

Since the corresponding rim of the outlet opening and/or of the slide extends at a slant relative to the displacement direction of the slide, the outlet cross section of the outlet opening is enlarged gradually, as a function of the displacement travel of the slide. In this manner, the metering rate can be optimally adapted to the respective bulk material. Since the outlet cross section of the outlet opening depends on the displacement travel of the slide, flexible metering quantities can be adjusted without problem.

Since the slide can be advantageously displaced in a continuous fashion into various positions between the closed position and the maximally open position, a precise metering, even for small bulk material throughputs, is ensured.

The corresponding rim of the outlet opening and/or of the slide can be straight but also can extend curved, for example. Due to the slanted position in relation to the displacement direction of the slide, it is achieved even in such cases that the outlet cross section of the outlet opening changes as a function of the displacement travel of the slide.

In an advantageous embodiment, the rim of the outlet opening is designed in a V-shape. Due to this configuration, very small outlet cross sections can be adjusted through which the bulk material can properly exit from the metering container to the exterior.

It is advantageous when the rim of the slide is designed in a V-shape. In this way, very small outlet cross sections can be adjusted also.

For the V-shaped configuration of the rim of the outlet opening or of the slide, the respective other rim can be designed straight but also so as to extend curved.

It is advantageous when the rim of the outlet opening and the rim of the slide are each V-shaped, respectively. In this case, the two rims are provided relative to each other such that the rim of the outlet opening extends in one displacement direction and the rim of the slide in the other displacement direction of the slide.

It is particularly advantageously when the rim of the slide is embodied mirror-symmetrically to the rim of the outlet opening. This has the result that the outlet cross section, independent of the position of the slide, has a quadrangular contour at all times. The farther the slide is displaced away from the closed position, the larger the height of the outlet cross section measured in the direction of the displacement direction.

In order to achieve a high precision and optimal adaptation of the metering rate even for a constructively simple configuration of the metering device, the outlet opening is provided at a container wall and/or at a holding plate which is fastened to the metering container.

It is advantageous in this context when the slide is slidable in contact with the container wall or the holding plate. In this way, the slide can be displaced reliably into the desired position; this contributes to a good adaptation of the metering rate.

A further improvement is achieved when the slide is guided by at least one guide element, preferably a guide plate, during its displacement movement.

The guide element is fastened to the container wall or to the holding plate; this contributes to a constructively simple construction of the metering device.

The guide element cannot only serve for guiding the slide but, in an advantageous manner, can be provided for supporting the slide drive. Such a configuration contributes in an advantageous manner to a simple configuration of the metering device.

There is however also the possibility to support the slide drive at the container wall.

In order for the slide to be coupled in a simple manner to the slide drive, the slide is provided with at least one connection part that is projecting away from it and by means of which the slide is connected in driving connection to the slide drive. The connection part can be, for example, a tab that is projecting transversely away from the slide and that can be provided in a simple manner at the slide and ensures a simple connection to the slide drive.

The rim of the slide that delimits the respective outlet cross section of the outlet opening is its bottom rim, in relation to the closed position of the slide. In this way, the slide can be manufactured in a simple manner in that only the bottom rim of the slide must be appropriately configured.

As a result of the configuration according to the invention of the metering device, the bulk material flow of the metering action is determined by the displacement travel of the slide and the slide geometry and/or the geometry of the outlet opening. By displacement of the slide, the opening rim or the outlet cross section can be variably adjusted. With the metering device according to the invention, a coarse and fine flow metering is possible, i.e., large and small metering quantities are possible with one and the same metering.

In an advantageous embodiment, the slide drive is connected to a control unit with which the displacement speed of the slide can be controlled. In this manner, variable opening speeds can be achieved when extending and retracting the slide. In order to determine the position of the slide reliably and still in a simple manner, advantageously a travel measuring system is provided that determines the displacement travel of the slide and is connected to the control unit.

The travel measuring system can be designed such that it directly determines the displacement travel of the slide. For this purpose, for example, corresponding measuring sensors can be used that determine the respective position of the slide and send corresponding signals to the control unit.

The displacement travel of the slide can however also be determined indirectly by the travel measuring system. In this case, data of the slide drive are acquired and evaluated. For example, the slide drive can comprise a threaded spindle wherein the rotation of the threaded spindle is determined and, based thereon, the position of the slide is determined.

In a particularly advantageous embodiment, the control unit evaluates standard deviations of the metering constancy and calculates them. Based on the calculation taking into account the bulk material flow, the outlet cross section of the outlet opening, and the metering time, the control unit then determines the optimal slide position. In this manner, a maximum metering precision is achieved.

It is advantageous when the control unit is designed to be intelligent and can comprise algorithms for self adaptation and self optimization of the metering process with different bulk materials.

It is particularly advantageous when flow properties of the respective bulk material are stored in the control unit. Then, the control unit can also take into consideration the determined and stored flow properties of the respective bulk material for adjustment of the slide. In particular, the specific metering rate for the bulk material can be automatically determined in this manner.

By means of the control unit, it is possible to calculate the ideal outlet cross section, in relation to the maximum metering precision and a minimal metering time.

The subject manner of the application results not only from the subject matter of the individual claims but also from all specifications and features disclosed in the drawings and the description. Even though they are not subject matter of the claims, they are claimed as being important to the invention as far as, individually or in combination, they are novel in relation to the prior art.

Further features of the invention result from the further claims, the description, and the drawings.

### BRIEF DESCRIPTION OF THE DRAWINGS

The invention will be explained in the following in more detail based on some embodiments illustrated in the drawings.

FIG. 1 shows in perspective illustration a metering device according to the invention.

FIG. 2 shows in exploded illustration a metering member of the metering device according to the invention.

FIG. 3 shows in perspective illustration the metering member with large outlet opening.

FIG. 4 shows in perspective illustration the metering member with small outlet opening.

FIGS. 5a, 5b, 5c, 5d show in schematic illustration different configurations of the rim of the outlet opening of the metering member.

### DESCRIPTION OF PREFERRED EMBODIMENTS

The metering device has a metering container 1 in which the materials to be metered (bulk material) are contained.

The metering container has a bottom 2 that is positioned at a slant and by means of which the materials can slide in downward direction to an outlet opening 3.

The outlet opening 3 is provided at a metering member 4 which is arranged in a sidewall 5, in the embodiment in the rear wall, of the metering container 1. Through the outlet opening 3, the metered material flows downwardly into a receiving container (not illustrated) in which a mixing device can be provided. The receiving container is located advantageously above a processing machine with which the materials are processed in a manner known in the art.

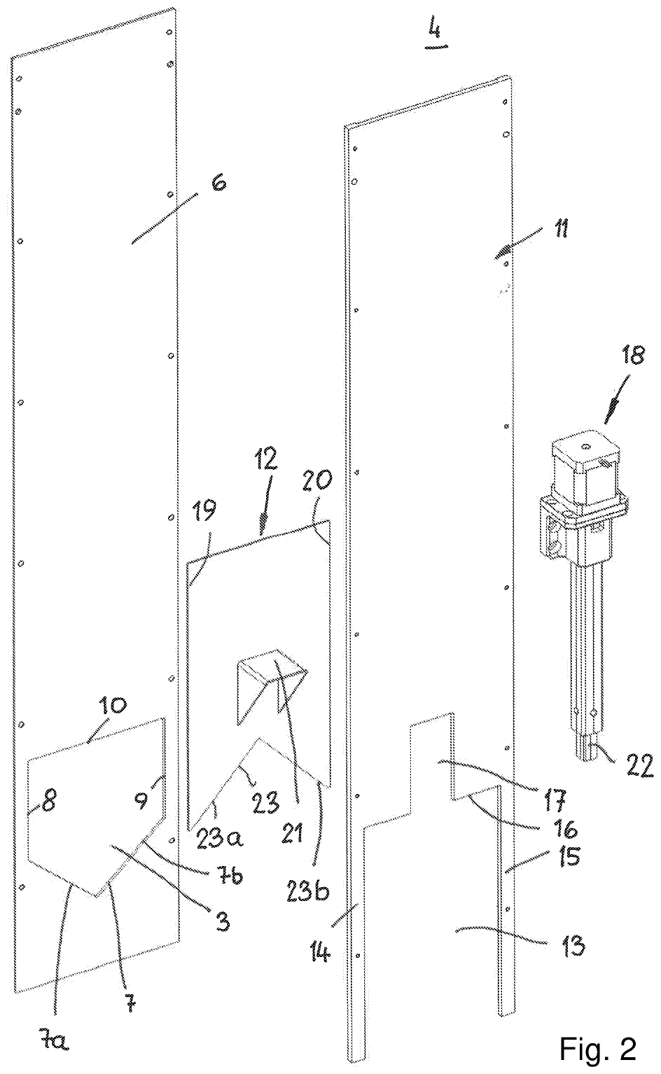

The metering member 4 has a holding plate 6 (FIG. 2) which, in the embodiment, has a rectangular shape; depending on the configuration of the metering container 1, it can also have any other suitable shape.

In the embodiment, the holding plate 6 is fastened in vertical orientation at the metering container 1. At the bottom end, the holding plate 6 is provided with the outlet opening 3 whose bottom rim 7 is embodied at a slant in relation to the length direction of the holding plate 6.

The specifications “bottom” and “top” relate to the position in the drawings.

The rim 7 is advantageously of a V-shaped configuration and designed symmetrically to the longitudinal center axis of the holding plate 6.

Lateral rims 8 and 9 extending in longitudinal direction of the holding plate 6 adjoin the rim 7 and are connected at the top end by a transverse rim 10.

A guide element 11 is fastened at the holding plate 6 and advantageously has the same contour shape as the holding plate 6 and is preferably a guide plate that requires only little installation space and is a simple, inexpensive component.

The guide plate 11 serves for guiding a slide 12 that is arranged between the holding plate 6 and the guide plate 11. By means of the slide 12, the through cross section of the outlet opening 3 is adjusted in a way to be described in the following.

The guide plate 11 is provided at the bottom region with a cutout 13 that is open in downward direction and delimited at the sides by narrow strips 14, 15. The cutout 13 is delimited in upward direction by a rim 16 extending perpendicularly to the two strips 14, 15 and, at half its length, a narrow cutout 17 opens into the cutout 13. In longitudinal direction of the guide plate 11, the cutout 17 is significantly shorter than the cutout 13.

The guide plate 11 is fastened with intermediate positioning of the slide 12 at the holding plate 6. The slide 12 is arranged in the region of the cutout 13 of the guide plate 11.

At the side which is facing away from the holding plate 6, a drive 18 is arranged on the guide plate 11 with which the slide 12 can be displaced continuously in longitudinal direction of the guide plate 11 or of the metering member 4. The drive 18 is a linear drive, preferably a spur gear motor, by means of which the slide 12, for adjustment of the outlet cross section of the outlet opening 3, can be moved continuously in longitudinal direction of the guide plate 11.

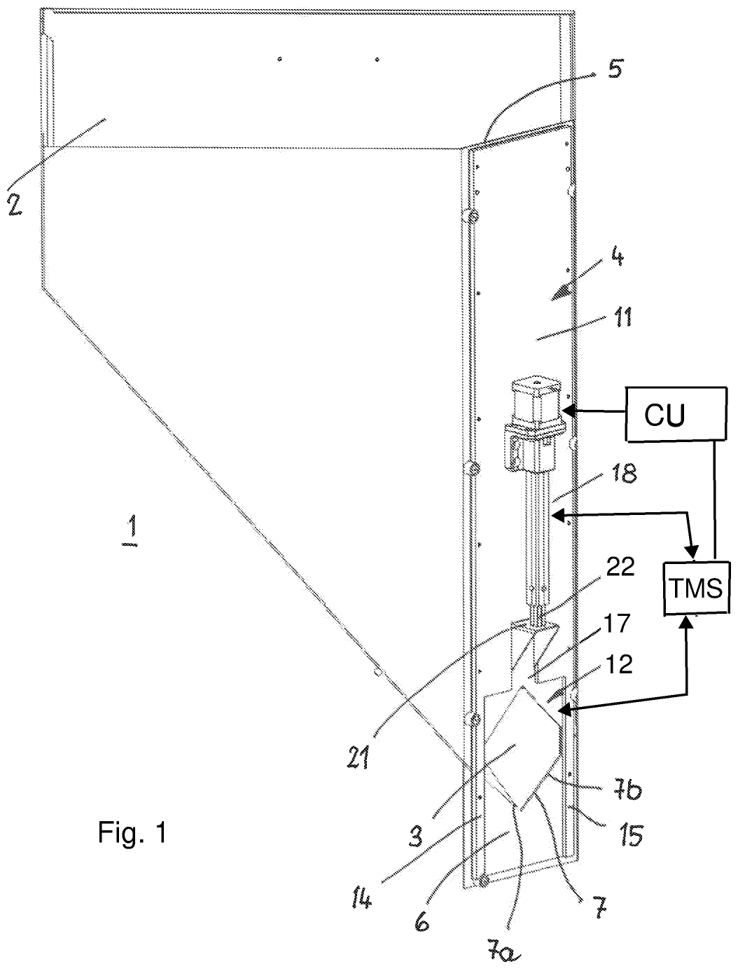

The slide 12 is also of a plate-shaped configuration and has a rectangular contour. The longitudinal rims 19, 20 of the slide 12 are engaged across by the guide strips 14, 15 of the guide plate 11 (FIGS. 1 and 2).

The slide 12 is provided with a tab 21 that, depending on the position of the slide 12, projects into the cutout 13 or into the cutout 17 of the guide plate 11. The bottom end of a drive rod 22 of the drive 18 is attached to the transversely projecting tab 21. For adjustment of the slide 12, the drive rod 22 is displaced in its longitudinal direction.

The bottom rim 23 of the slide 12 is embodied in a V-shape in the embodiment. The two rim sections 23a, 23b are positioned in an exemplary fashion at a 90° angle to each other. In the same manner, also the rim sections 7a, 7b of the rim 7 of the outlet opening 3 are positioned at a right angle to each other. The rims 7, 23 of the outlet opening 3 and of the slide 12 are oriented opposite to each other (FIGS. 2 to 4). Advantageously, the rims 7, 23 have the same dimensions.

The rim sections 7a, 7b; 23a, 23b can also be positioned at other angles relative to each other.

With the drive 18, the slide 12 can be displaced so far downwardly that the outlet opening 3 of the holding plate 6 is completely closed. The drive rod 22 is correspondingly extended far out.

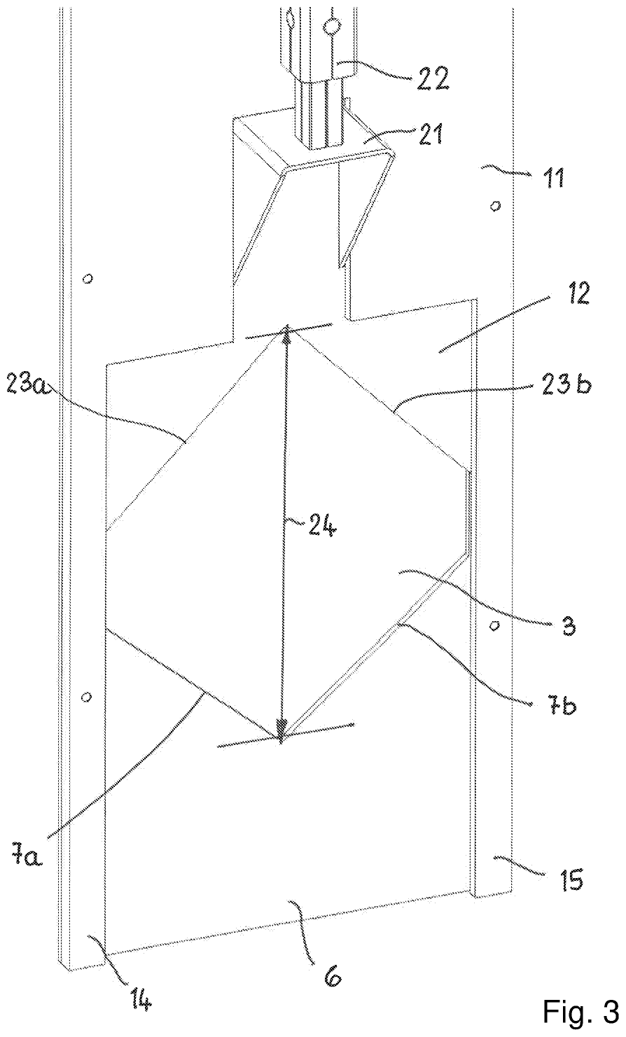

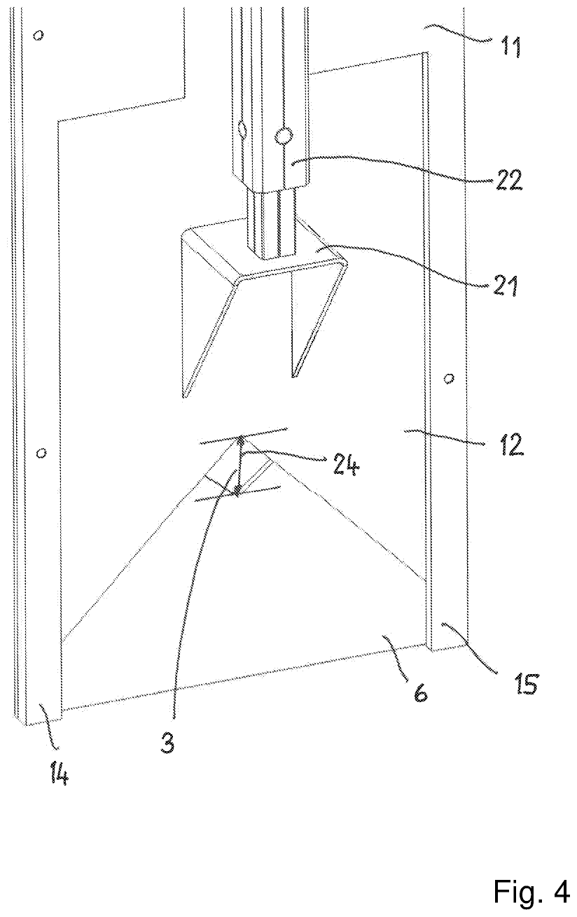

With the drive 18, the slide 12 can be continuously displaced. When the drive rod 22 is retracted, the slide 12, because it is connected by the tab 21 to the drive rod 22, is moved in upward direction in the illustration according to FIGS. 3 and 4.

FIG. 4 shows in an exemplary fashion that the slide 12 has been displaced by a relatively minimal travel away from its initial position.

Beginning at a predetermined displacement travel, the slide 12 partially opens the outlet opening 3.

FIG. 4 shows a position of the slide 12 in which the outlet opening 3 has only a small opening cross section. The outlet opening is delimited by the V-shaped rims 7, 23 of the holding plate 6 and of the slide 12. In displacement direction of the slide 12, the outlet opening 3 has the height 24.

FIG. 3 shows the situation when the slide 12 is maximally displaced upwardly. In this case, the outlet opening 3 has the maximum height 24. In this position of the slide 12, the outlet opening 3 has its largest cross section. The outlet opening 3 is delimited by the rim sections 7a, 7b of the holding plate 6 and the rim sections 23a, 23b of the slide 12.

The tab 21 is positioned in this maximum displacement position of the slide 12 within the cutout 17 of the guide plate 11. Advantageously, the tab 21 in this position is contacting the top rim of the cutout 17 which then serves as a stop for the tab 21. In this way, the slide 12 can be displaced simply into the maximum opening position.

Since the slide 12 is continuously adjustable by the drive 18, the opening cross section of the outlet opening 3 can be adjusted continuously in accordance therewith. Thus, the metering rate can be very precisely adjusted.

Since the holding plate 6 is fastened fixedly to the metering container 1, the respective required opening cross section of the outlet opening 3 can be adjusted by the displacement travel of the slide 12. The displacement travel of the drive rod 22 can be determined by sensors. The respective displacement travel of the drive rod 22 and thus of the slide 12 determines immediately the opening cross section of the outlet opening 3.

The slide 12 can be displaced reliably between the holding plate 6 and the guide plate 11. The holding plate 6 serves in this context as a support for the slide 12 that thereby can be reliably displaced.

The guide plate 11 is fastened to the holding plate 6 such that the slide 12 has hardly any clearance between the holding plate 6 and the guide plate 11. In this manner, the slide 12 can be adjusted properly and at high speed into the desired position by the drive 18.

The guide plate 11 can be designed such that, at its inner side facing the holding plate 6, it has guides that extend in the displacement direction and at which the slide 12 with its longitudinal rims 19, 20 is guided in displacement direction.

Since in the embodiment the rim 7 and the rim 23 are each of a V-shaped configuration, the outlet opening 3 has a corresponding angular contour for any cross section size, as illustrated in FIGS. 3 and 4, for example.

Due to the special configuration of the rims 7, 23, it is achieved that the outlet cross section of the outlet opening 3 can be adjusted precisely. Since the two rims 7, 23 are designed mirror-symmetrically to the longitudinal axis of the holding plate 6 or the guide plate 11, the outlet opening 3, independent of its cross section size, is always central within the metering member 4.

In this way, the material from the metering container 1 can always flow out through the outlet opening 3 without disturbance.

The drive 18 can be designed in various ways. For example, the drive 18 can be a spindle that is driven by a step motor, as shown in the embodiment. As a drive, also a linear carriage can be provided which is displaced along the guide plate 11 in order to displace the slide 12 into the various positions.

Furthermore, there is the possibility of employing a pneumatic drive as a drive.

Purely mechanical solutions in the form of, for example, an elbow lever, are conceivable also with which the slide 12 can be displaced into any desired position.

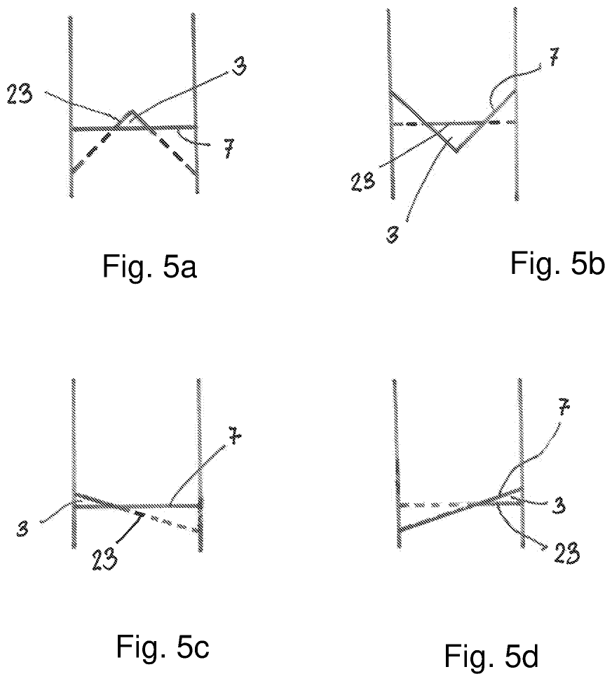

FIGS. 5a, 5b, 5c, 5d show different configurations of the rims 7, 23 of the holding plate 6 as well as of the slide 12. With the aid of FIGS. 5a, 5b, 5c, 5d, further configurations of the rims 7, 23 will be explained in an exemplary fashion. For reasons of simplification, only the rims 7, 23 are illustrated in FIGS. 5a, 5b, 5c, 5d.

FIG. 5a shows the possibility that the rim 7 of the holding plate 6 extends straight while the rim 23 of the slide 12 has the described V-shape. The rim 7 of the holding plate 6 extends in this case perpendicularly to the displacement direction of the slide 12.

As illustrated in FIG. 5b, it is also possible that only the rim 7 of the holding plate 6 is designed in the described manner in a V-shape. The rim 23 of the slide 12 extends in this case straight, namely perpendicularly to the displacement direction of the slide 12.

FIG. 5c shows the possibility of configuring both rims 7, 23 to be straight across their length. In this case, the straight rim 7 of the holding plate 6 extends perpendicularly to the displacement direction of the slide 12 while the rim 23 extends angularly to the displacement direction of the slide 12.

The embodiment according to FIG. 5d is characterized in that the rim 23 of the slide 12 extends perpendicularly to the displacement direction of the slide while the rim 7 of the holding plate 6 extends at an angle at a slant to the displacement direction of the slide 12.

In principle, there is the possibility to configure the rims 7, 23 or also the rim sections 7a, 7b; 23a, 23b to be curved instead of straight.

Finally, it is also possible that, in the embodiments according to FIGS. 5c and 5d, both rims 7, 23 extend each at a slant to the displacement direction of the slide 12.

In the embodiments illustrated in FIGS. 5a to 5d, the outlet opening 3 does not have a rectangular but a triangular contour.

In these variants according to FIGS. 5a, 5b, 5c, 5d, the cross section of the outlet opening 3 can also be continuously and finely adjusted as a function of the displacement travel of the slide 12.

It is advantageous when the slide drive 18 is connected to a control unit CU with which the displacement speed of the slide 12 can be controlled. It is then possible to achieve variable opening speeds when displacing the slide 12.

In order for the position of the slide 12 to be determined reliably and in a simple manner, advantageously a travel measuring system TMS can be used with which the displacement travel of the slide 12 can be determined directly or indirectly. The travel measuring system TMS can be formed, for example, by travel measuring sensors that determine the respective position of the slide 12 and send corresponding signals to the control unit CU. By means of these measuring signals, the control unit CU can control the drive 18 such that the slide 12 is adjusted into the exact position with a speed that is as optimal as possible.

In principle, it is also possible to determine the position of the slide 12 indirectly by the travel measuring system TMS. For example, the rotational travel of a spindle can be determined based on which then the displacement position of the slide 12 can be determined. This determination is carried out in the control unit CU which receives the corresponding measured travel signals.

In order to obtain a maximum metering precision, the control unit CU is designed such that it evaluates and calculates standard deviations of the metering constancy. Based on this calculation, the control unit CU, taking into consideration the bulk material flow, the outlet cross section of the outlet opening 3, and the metering time, can determine the optimal slide position.

The control unit CU can be designed to be intelligent and contain algorithms for self adaptation and self optimization of the metering process with different bulk materials.

It is particularly advantageous in this connection when flow properties of the respective bulk material are stored in the control unit CU. Then, upon adjustment of the slide 12, the control unit CU can also take into consideration the determined and stored flow properties of the respective bulk material. In particular, in this manner the metering rate that is specific for the bulk material can be automatically determined also.

By means of the control unit CU, it is thus possible to calculate the ideal outlet cross section in relation to the maximum metering precision and a minimal metering time.

In deviation from the illustrated embodiment, the guide element 11 can be attached directly to the container wall 5. A holding plate can be omitted in this case. Depending on the configuration of the guide element 11, the drive 18 can be attached then to the container wall 5. It comprises a projecting carrier to which the drive 18 is fastened. The guide element 11 is arranged in the region between the carrier and the outlet opening 3. In this context, the guide element 11 can be designed, for example, in a block shape so that it can reliably guide the slide 12.

The specification incorporates by reference the entire disclosure of German priority document 10 2021 005 028.2 having a filing date of Oct. 5, 2021.

While specific embodiments of the invention have been shown and described in detail to illustrate the inventive principles, it will be understood that the invention may be embodied otherwise without departing from such principles.

What is claimed is:

1. A metering device for bulk material, the metering device comprising:
a metering container comprising an outlet opening comprising a rim;
a slide connected to a slide drive and configured to close the outlet opening;
the slide comprising a slide rim;
the rim of the outlet opening and the slide rim, as a function of a displacement travel of the slide in a displacement direction, determining a travel-dependent outlet cross section of the outlet opening;
the rim of the outlet opening and/or the slide rim extending at a slant to the displacement direction of the slide.

2. The metering device according to claim 1, wherein the rim of the outlet opening comprises a V-shape.

3. The metering device according to claim 1, wherein the slide rim comprises a V-shape.

4. The metering device according to claim 1, wherein the rim of the outlet opening comprises a V-shape and wherein the slide rim comprises a V-shape.

5. The metering device according to claim 4, wherein the slide rim is mirror-symmetrical to the rim of the outlet opening.

6. The metering device according to claim 1, wherein the outlet opening is provided at a container wall of the metering container or at a holding plate that is fastened to the metering container.

7. The metering device according to claim 6, wherein the slide is configured to slide in contact with the container wall or the holding plate.

8. The metering device according to claim 1, further comprising a guide element configured to guide the slide during a displacement movement of the slide.

9. The metering device according to claim 8, wherein the guide element is a guide plate.

10. The metering device according to claim 8, wherein the guide element is fastened to a container wall of the metering container or to a holding plate that is fastened to the metering container.

11. The metering device according to claim 8, wherein the slide drive is supported at the guide element or at a container wall of the metering container

12. The metering device according to claim 1, further comprising a connection part connected to and projecting away from the slide, wherein the slide is in drive connection with the slide drive through the projecting connection part.

13. The metering device according to claim 1, wherein the slide rim delimiting the travel-dependent outlet cross section of the outlet opening is a bottom rim of the slide.

14. The metering device according to claim 1, further comprising a control unit connected to the slide drive and configured to control a displacement speed of the slide.

15. The metering device according to claim 14, further comprising a travel measuring system connected to the control unit and configured to determine the displacement travel of the slide.

16. The metering device according to claim 15, wherein the travel measuring system is configured to directly determine the displacement travel of the slide.

17. The metering device according to claim 15, wherein the travel measuring system is configured to indirectly determine the displacement travel of the slide by acquiring data of the slide drive.

18. The metering device according to claim 14, wherein the control unit evaluates and calculates standard deviations of a metering constancy and determines an optimal position of the slide based on the calculated standard deviations, taking into consideration a bulk material flow, the travel-dependent outlet cross section of the outlet opening, and a metering time.

19. The metering device according to claim 14, wherein flow properties of the bulk material are stored in the control unit.
